(19) United States
(12) Patent Application Publication
(10) Pub. No.: US 2009/0133087 A1
(43) Pub. Date: May 21, 2009

(54) METHOD FOR DEVISING A COMMUNICATION PLATFORM WHICH CAN DISPLAY THE MEDIA ADVERTISEMENT AUTOMATICALLY

(76) Inventor: Shih-Hsien YANG, Taipei City (TW)

Correspondence Address: BIRCH STEWART KOLASCH & BIRCH, PO BOX 747, FALLS CHURCH, VA, 22040-0747, US

(21) Appl. No.: 11/944,301

(22) Filed: Nov. 21, 2007

(51) Int. Cl. H04N 7/173

(52) U.S. Cl. 725/116

(57) ABSTRACT

A method for devising a communication platform that can play the media advertisement automatically. After a computer is logged on, a user is connected to the communication platform. A network media advertisement is displayed through the reception of a network control signal by network. Or a custom media advertisement is played by a media player under a time period. After the playing of a custom media advertisement or a network media advertisement, the communication platform is connected to. A custom media advertisement or a network media advertisement is played by the above mentioned methods.

### FIELD OF THE INVENTION

The present invention is related to a method for devising communication platform, it specifically relates to a design method for automatically playing media advertisement communication platform.

### BACKGROUND OF THE INVENTION

Communication platform has now become an indispensable communication tool for using computer in the internet by people nowadays. No matter it is chat room such as MSN or Skype, or the communication platform such as message board, they all own a great deal of users; meanwhile, communication platform has in the same time the advantages of achieving communication purpose as well as saving the telephone fee, it thus has certain degree of influence on the conventional telephone user or wireless telephone user.

The advancement in the network and computer technology has made the client end of computer achieve the function of communication through the use of communication platform. Take the chat room as an example, Commercially, supplier of the same industry has its own customer group, and the customer group of different supplier can use the chat room as a tool of building social relationship and sharing interest as well as habit. However, communication platform is only user communication platform and it does not have the function of playing media advertisement automatically; therefore, the supplier can not, while using communication platform, use again the function of automatic playing of media advertisement to increase the commercial added value. However, if the communication platform can have the function of playing commercial media advertisement at the same time, it can then be seen as a tool that has both chatting and media player function.

Therefore, it is desired to achieve the function of playing media advertisement automatically while using communication platform; that is, it is desired to let general supplier, in addition to using communication platform, can play media advertisement automatically; furthermore, it is desired that through the convenience of the internet, the internet media advertisement at different web sites can be played, and the content of media advertisement can become more diversified.

### SUMMARY OF THE INVENTION

The objective of the present invention is to provide a method for devising a communication platform that can play the media advertisement automatically so that the effect of automatic playing of media advertisement can be achieved through the internet.

The objective of the present invention is to provide a method for devising a communication platform that can play the media advertisement automatically so that the promotion of a commercial product can be achieved through the playing of media advertisement.

In order to achieve the above objective, the present invention mainly provides a method for devising a communication platform that can play media advertisement automatically; first, a computer is connected to a network so as to dialogue with an client end through a communication platform; in the method, a signal transmitted from the client end is detected so that when a network control signal is received, it is able to enter a designated web site to play a network media advertisement through the network and to enter the communication platform at the end; meanwhile, it is hoped that under a time period, it is able to play custom media advertisement through the use of media player and enter the communication platform at the end.

For the above mentioned method of devising a communication platform that can play media advertisement and in consideration of the order of playing of network media advertisement and the custom media advertisement, the playing of the network media advertisement will be taken as first priority.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is the flow chart of a method for devising communication platform that can play media advertisement automatically for the present invention;

FIG. 2 is the flow chart of the method of detection and playing of network media advertisement for the present invention;

FIG. 3 is the flow chart of the method of detection and playing of custom media advertisement for the present invention.

### DETAILED DESCRIPTION OF THE INVENTION

In order to let your esteemed examiner be able to understand further the techniques, means and performances taken in this invention in order to achieve the objective of the present invention, please refer to the detailed descriptions and attached drawing in the followings regarding the present invention; we believe that the objective, details and features of the present invention will be deeply understood thereof; however, the attached drawing is for reference and description purposes and is not used to limit the scope of the present invention.

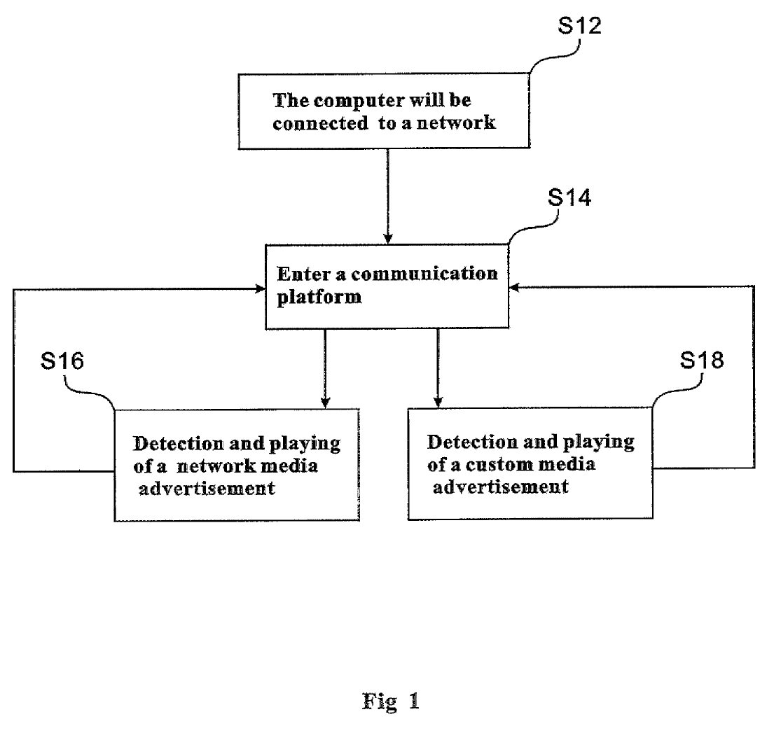

The flow chart of a method for devising communication platform that can play media advertisement automatically for the present invention is as shown in FIG. 1; after a computer is started, step S12 will be executed first and the computer will be connected to a network; then the computer will enter a communication platform, for example, through chatting room programs such as msn or skype, and the chatting room is used as communication platform for an user to one or multiple people in the client end, that is, step S14. The subsequent step S16 and step S18 are performed simultaneously, of course, it can only be just either step S16 or step S18 is designed; furthermore, step S16 is to perform the detection and playing of a network media advertisement, that is, to receive the signal transmitted from the client end and to play media advertisement of the video content in a designated web site address. However, step S18 is to perform the detection and playing of a custom media advertisement, that is, to detect the video content prepared by an user through media player so as to play a custom media advertisement in a time period. In the media player, a time period device is used to set up a critical value for time period, that is, when the time period counter reaches critical value, it will be zeroed and the counting will be performed again so that time periodicity can be achieved; for example, if we take time counter as a time period device and set the critical value of the time counter as 5 minutes, then the time period is five minutes. After the completion of step S16 or step S18, you can go back to step S14 and enter communication platform to repeat the above steps.

What needs to be noticed is, in the playing of either network media advertisement and custom media advertisement, you can take the playing of network media advertisement as first priority; for example, when the custom media advertisement is played but network media advertisement needs to be played too, you can then stop the playing of custom media advertisement and switch to the playing of network media advertisement as first priority. Of course, in the method of devising a communication platform that can play media advertisement automatically as of the present invention, the priority right of treatment can be changed according to different designers, for example, it can take priority-playing system, that is, either network media advertisement or custom media advertisement should be played first as the priority of treatment.

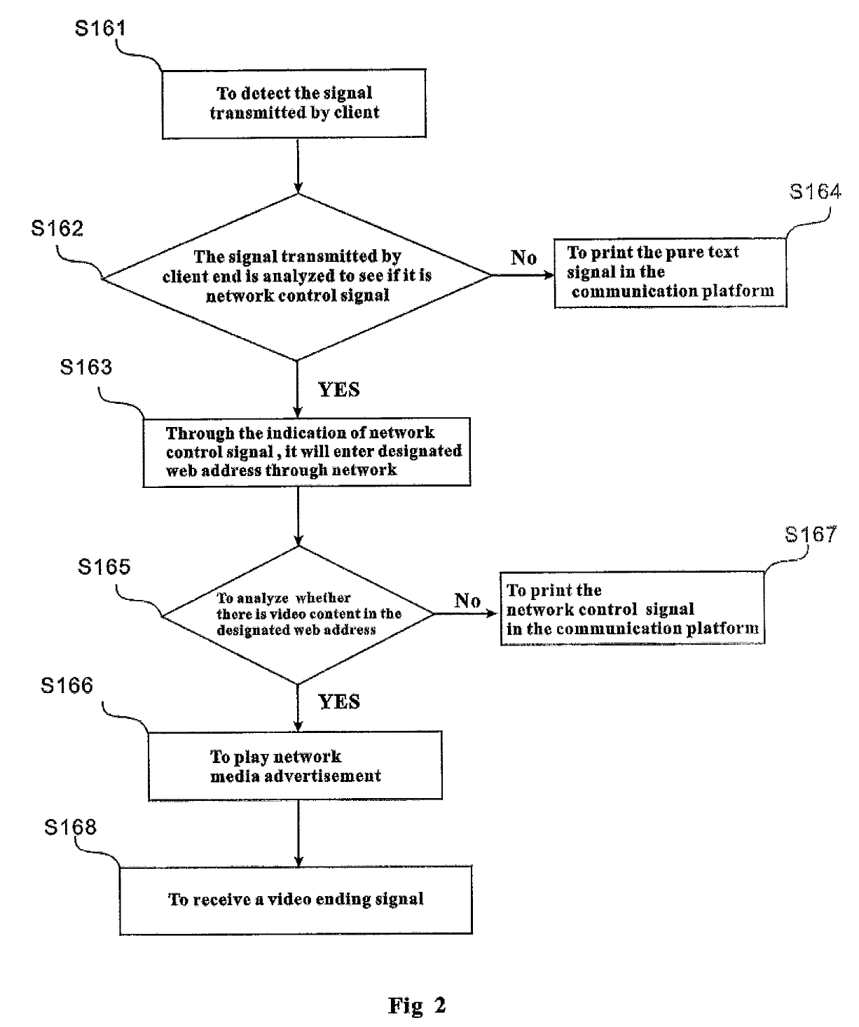

FIG. 2 is the method flow chart for the detection and playing of network media advertisement of the present invention, which is a further explanation of step S16 in FIG. 1. First, the signal transmitted from the client end is detected, here in the present invention, the signal transmitted from the client end is divided into pure text signal and network control signal; pure text signal means signal that does not contain designated web address information, and network control signal means signal that contains designated web address information, What needs to be noticed is, the signal transmission format of the network control signal will change with different design, the user and client end can coordinate the format; for example, common identification code can be set up to be used as representation of network control signal, of course, the simplest way is to use a format starting with http or even to designate completely the designated web address and use it as network control signal. Later on, the signal transmitted by client end is analyzed to see if it is network control signal, that is, the step S162.

Furthermore, the present invention uses a text analyzer to analyze the signal transmitted from client end so as to compare the identification code in the signal transmitted from client end; take the descriptions as mentioned in the last article, the text analyzer will analyze if the signal transmitted from client end starts with http, if no, it means the signal transmitted from client end is pure text signal, then step S164 will be performed to print the pure text signal in the communication platform and use it as the dialogue content between the client end and the user; later on, go back to step S14 to enter communication platform; however, if the signal transmitted from client end starts with http, it means that the signal transmitted from client end is network control signal, then S163 is performed; through the indication of network control signal, it will enter designated web address through network; since network control signal includes designated web address, it can then enter designated web address directly through the network.

After the completion of step S163, whether there is video content in the designated web address will be analyzed, which is step S165. In the present invention, web content analyzer is used to analyze if all kinds of video content formats are contained in designated web address, for example, avi file, dat file and wmv file or if it contains embedded code, or if it is web address that is thought of containing any video content by web content analyzer, if no, it means that designated web address does not contain any video content and the network media advertisement can not be played, then, step S167 is performed to print network control signal on communication platform and use it as the dialogue content between client end and the user; if so, it means that designated web address contains video content, it can then play directly network media advertisement, which is step S166. What needs to be noticed is, the playing of network media advertisement can be done through video player that supports video content format, of course, there are some web pages in some web addresses with embedded video player, the user does not need to set up additional video player to play directly network media advertisement, for example, YouTube. What needs to be noticed is, in the playing of network media advertisement, in order to avoid the effect of custom media advertisement part, the time period device will be closed. When network media advertisement is played completely, designated web address will transmit to the user a network media advertisement ending signal; therefore, after step S166, step S168 is preformed to receive a video ending signal to inform the user that the network media advertisement has been played completely, finally, when the video ending signal is received, the time period device is opened. After the completion of step S164, step S167 or step S168, it means that the detection and playing process flow of network media advertisement has been completed, and step S12 as in FIG. 1 is going to be returned to, that is, to return to communication platform.

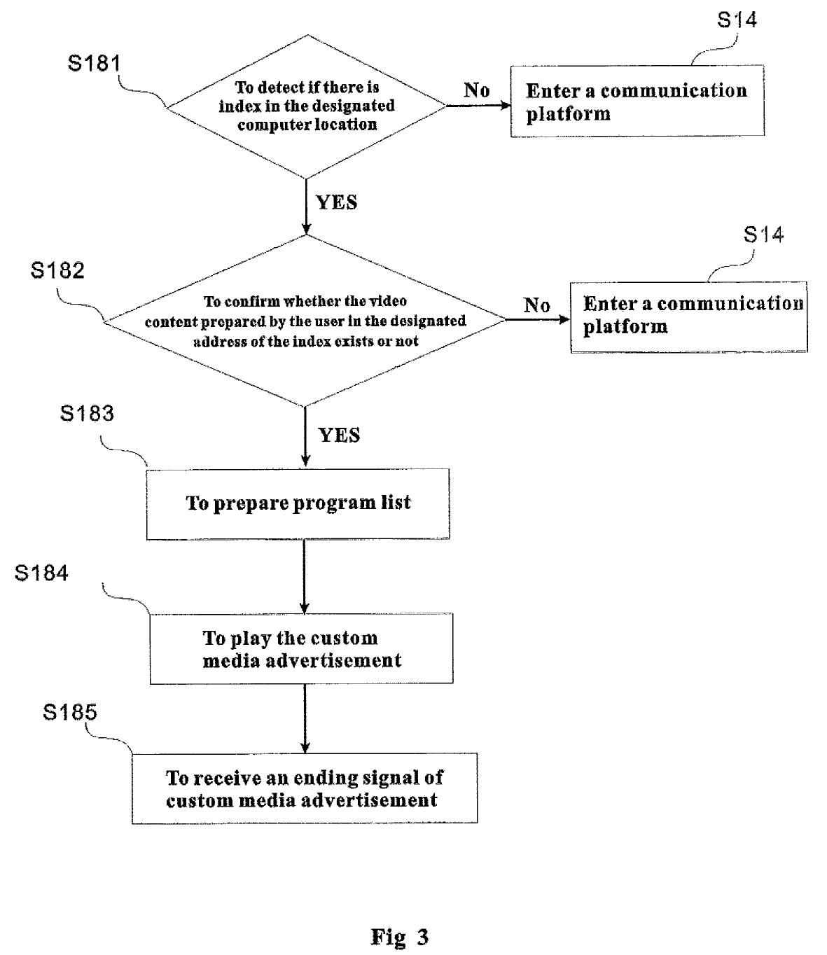

FIG. 3, is the method flow chart of the detection and playing of custom media advertisement of the present invention, that is, it is the further description of step S18 in FIG. 1. First, step S181 is performed, that is, to detect if there is index in the designated computer location, and the index is to designate more than one designated memory devices and the designated memory device is placed with the address that the user has prepared the video content. The address that is placed with the video content prepared by the user can be called designated address; designated memory device means computer hard disk drive, portable disk, etc. which can be used to store the video content prepared by the user; according to the designated address in the index, the video content prepared by the user is acquired and the custom media advertisement is played. If the index is not detected, then step S14 is performed and communication platform is entered; if yes, then step S182 is performed, and the designated memory device in the index is connected, and whether the designated memory device has video content prepared by the user will be analyzed. Performing step S182 is to confirm whether the video content prepared by the user in the designated address of the index exists or not, if no, then perform step S14 to enter communication platform; if yes, then perform step S183 to prepare program list, wherein, a program list is prepared through the designated addresses in the index; meanwhile, a custom media advertisement is selected from the program list, then after the implementation of step S183, the custom media advertisement will be played by the media player, which is step S184. In step S181, The designated addresses as marked by the index might be more than one, under such condition, when step S182 and S183 are performed, the prepared program list will only be marked with effective designated address, that is, the video content prepared by the user at the designated address does exist.

In step S184, after the completion of the paying of custom media advertisement, the media player will transmit to the user an ending signal for custom media advertisement; therefore, after step S184, it is to perform step S185 so as to receive an ending signal of custom media advertisement so as to inform that the custom network media advertisement has been played completely and to enter communication platform.

What needs to be noticed is, in the detection and playing method of the custom media advertisement of the present invention, the time period device needs to be closed when step S184 is to be performed so as to avoid the effect of time period device; therefore, after the completion of step S185, in addition to entering communication platform, the time period device needs to be opened at the same time. After the opening of the time period device, the method of detection and playing of custom media advertisement will be performed again.

According to the design method of the present invention, the detection and playing of custom media advertisement is performed at each time period; if the program list contains several designated addresses, that is, custom media advertisements that can be played are more than one, but at each time period, only one section of custom media advertisement will be played; of course, the content of custom media advertisement will change with the different video content as prepared by the user; meanwhile, the method of playing custom media advertisement, based on the design requirement, can be either random number playing or following the order of program list. Take the random number playing as an example, when step S183 is performed, the designated address in one of the program list will be chosen in random number way.

Take the order playing as an example, when step S183 is performed, the video content prepared by the user is selected through program list index and remainder theorem (Mod). If in the index, there is only one designated address, it means that the index only marks one video content made by the user, and the prepared program list has only one designated address; at this moment and in each time period when the custom media advertisement is detected and played, only the custom media advertisement, which is video content prepared by user in the designated address, will be repeatedly played.

What needs to be noticed is, when Msn communication platform program is used and when the computer is turned off, the account set up by the user will disappear, and the user can not receive any signal transmitted by the client end. However, when the communication platform program of Skype is used, the user set up an account so that the location in the network of the network central server is used as communication platform; therefore, when the computer is turned off, the account set up by the user will not disappear, and each client end can still use communication platform of this account as the communication platform; furthermore, the signal transmitted by each client end to the user will be stored in the network location as historical information, until the next time when the user enter again the communication platform, the user can receives these historical information, but these historical information can only be used as pure text signal.

Custom media advertisement is mainly completed by the video prepared by an user, and network media advertisement, however, is video content prepared by client end and then placed in designated web address; then through the detection and playing method of custom media advertisement and network media advertisement of the present invention, we can then play media advertisement automatically so as to increase the commercial value of communication platform. What needs to be noticed is, the playing of media advertisement is done through the propagation in the network; in addition to the user of communication platform, each of the client end of the communication platform can prepare client end video content, then through the convenience of the network, the client end prepared video content is placed in designated web address so as to increase the supply speed of video content. In addition, commercially and for the product of the supplier, the user or the client end achieves the promotional effect of the product through the preparation of user prepared video content and client end prepared video content.

Although the present invention has been disclosed as above through a preferred embodiment and the figures, it is indeed to describe but not limit the scope of the present invention. Any one who is familiar with the prior art can make any kinds of equivalent change and modification without deviating from the spirit and scope of the present invention. Therefore, the scope of the present invention should be defined by what is claimed.

What is claimed is:

1. A method for devising a communication platform that can play the media advertisement automatically. A computer is connected to a network, so as to run a communication platform and to dialogue with a client end, the method comprising of the following steps:
detecting the signal transmitted from a client end so that when a network control signal is received, it enters a designated web address through the network to play a network media advertisement, and after the completion, it enters the communication platform.

2. The method for devising a communication platform that can play the media advertisement automatically as of claim 1 further comprising of, under a time period, the use of a media player to play a custom media advertisement, and after the completion, enter the communication platform.

3. The method for devising a communication platform that can play the media advertisement automatically as of claim 2 further comprising of, while playing at the same time the network media advertisement and the custom media advertisement, taking the playing of the network media advertisement as the first priority.

4. The method for devising a communication platform that can play the media advertisement automatically as of claim 1 wherein the step of detecting the signal transmitted from the client end is through a text analyzer to analyze the signal transmitted by the client end so as to judge whether it is a pure text signal or the network control signal.

5. The method for devising a communication platform that can play the media advertisement automatically as of claim 1 wherein the steps of playing the network media advertisement comprising of:
using a web content analyzer to analyze if the designated web address contains the video content; and playing the network media advertisement while the video content exists, and enters the communication platform after the completion.

6. The method for devising a communication platform that can play the media advertisement automatically as of claim 5 wherein the step of playing the network media advertisement comprises, after the completion of the playing of the network media advertisement, the reception of a network media advertisement ending signal so as to enter the communication platform.

7. The method for devising a communication platform that can play the media advertisement automatically as of claim 2 wherein under the time period, the step of using the media player is to use time counter as the counting of time period.

8. The method for devising a communication platform that can play the media advertisement automatically as of claim 2 wherein the steps of using the media player to play the custom media advertisement comprising of:
detecting an index, so as to get connected to a designated device through the index; meanwhile, the designated memory device is analyzed to see if it contains user prepared video content;
preparing a program list while the video content exists; and
playing the custom media advertisement and entering the communication platform after the completion.

9. The method for devising a communication platform that can play the media advertisement automatically as of claim 8 wherein the steps of playing the custom media advertisement comprising of, after the completion of the custom media advertisement, the reception of a custom media advertisement ending signal so as to enter the communication platform.
